(19) United States
(12) Patent Application Publication
(10) Pub. No.: US 2013/0163113 A1
(43) Pub. Date: Jun. 27, 2013

(54) BASE FOR MOTOR AND HARD DISK DRIVE INCLUDING THE SAME

(71) Applicant: Il Geun JEON, Hwaseong (KR)

(72) Inventor: Il Geun JEON, Hwaseong (KR)

(73) Assignee: SAMSUNG ELECTRO-MECHANICS CO., LTD., Suwon (KR)

(21) Appl. No.: 13/402,372

(22) Filed: Feb. 22, 2012

(30) Foreign Application Priority Data
Dec. 23, 2011 (KR) 10-2011-0141674

(51) Int. Cl. G11B 21/02; H02K 5/00

(52) U.S. Cl. 360/75; 310/91; G9B/21.003

(57) ABSTRACT

There are provided a base for a motor and a hard disk drive including the same. The base for a motor includes a base body having a disk disposed thereon; and a fixing part formed on the base body and slidably fitted in a female rail mounted on at least one side of a connector part mounted on a substrate to fix the base body to the substrate to which power is applied.

### CROSS-REFERENCE TO RELATED APPLICATIONS

This application claims the priority of Korean Patent Application No. 10-2011-0141674 filed on Dec. 23, 2011, in the Korean Intellectual Property Office, the disclosure of which is incorporated herein by reference.

### BACKGROUND OF THE INVENTION

1. Field of the Invention

The present invention relates to a base for a motor and a hard disk drive including the same, and more particularly, to a base for a motor and a hard disk drive including the same, capable of improving a coupling structure of a base and a substrate.

2. Description of the Related Art

A hard disk drive (HDD), a computer information storage device, reads data stored on a disk or writes data to the disk using a magnetic head.

In a hard disk drive, abase has a head driver installed thereon, that is, a head stack assembly (HSA), capable of altering a position of the magnetic head relative to the disk. The magnetic head performs its function while moving to a desired position in a state in which it is suspended above a writing surface of the disk by the head driver at a predetermined height.

According to the related art, in manufacturing a base provided in the hard disk drive, a post-processing scheme of die-casting aluminum (Al) and then removing burrs, or the like, generated due to the die-casting has been used.

However, in a die-casting process according to the related art, since a process of injecting molten aluminum (Al) for forging into a mold to form a shape for a component is performed, high temperatures and pressure are required, such that a large amount of energy is required in the process and a process time is increased.

Further, even in terms of a lifespan of a die-casting mold, there is a limitation in manufacturing a large number of bases using a single mold, and a base manufactured by the die-casting process has defects in dimensional precision.

Therefore, in order to solve defects in the die-casting process, the base is manufactured by using a press or forging process. However, in the case of the press or forging method, there are limitations in that plates may inevitably have a uniform thickness through process of bending and cutting the plates.

Therefore, in the case of manufacturing the base by the press or forging method, it may be difficult to simultaneously satisfy front and back shapes of the base and to manufacture a coupling part due to a nut required for fixing a substrate.

Therefore, research for allowing the base to have improved structure by overcoming limitations in which the base inevitably has a uniform thickness, even in the case in which the base is manufactured through a press or forging method, is urgently needed.

### RELATED ART DOCUMENT

(Patent Document 1) Japanese Patent Laid-Open Publication No. 2000-245122
(Patent Document 2) Japanese Patent Laid-Open Publication No. 2002-335084

### SUMMARY OF THE INVENTION

An aspect of the present invention provides a base for a motor and a hard disk drive including the same, in which productivity is improved and production costs are significantly reduced by simplifying a coupling structure of a base and a substrate while using a press or forging method.

According to an aspect of the present invention, there is provided a base for a motor, including: a base body having a disk disposed thereon; and a fixing part formed on the base body and slidably fitted in a female rail mounted on at least one end of a connector part mounted on a substrate to fix the base body and the substrate to which power is applied.

The fixing part may be a male rail protruded in a lateral direction of the connector part so as to be slidably fitted in the female rail.

The male rail may be formed by depressing a surface of a predetermined region of the base body to protrude the other surface thereof.

The male rail may be formed by bending a predetermined region of the base body.

The male rail may be a burring process on the predetermined region of the base body.

The base body may include at least one female thread so as to be additionally screw coupled with the substrate.

The base body may be formed by a press process.

According to another aspect of the present invention, there is provided a hard disk drive, including: the base for a motor according to the embodiment; a spindle motor coupled to the base for a motor and rotating the disk by the power applied through the substrate; a magnetic head writing data to the disk and reproducing the data stored on the disk; and a head driver moving the magnetic head to a predetermined position with regard to the disk.

The substrate may have a connector part mounted to be protruded from one surface thereof.

The base for a motor may be depressed such that a motor seating part is formed on one surface of the base body and include a rear protrusion part partially protruded to the other surface thereof and, a predetermined region of the substrate may include a seating hole to allow the rear protrusion part to be fitted therein.

The seating hole of the substrate may have a larger diameter in a length direction than that of the rear protrusion part so that the rear protrusion part is axially fitted in the seating hole of the substrate and then, slidably coupled thereto in the length direction by a predetermined distance in a state in which the rear protrusion part is fitted in the seating hole of the substrate.

The rear protrusion part may serve as a stopper at a time of sliding coupling of the substrate.

The substrate may include a screw coupling hole at a position corresponding to a female thread mounted on the base body of the base for a motor, thereby being additionally screw coupled with the base body.

The substrate may be additionally screw coupled with the base body after sliding coupling of the substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically showing a hard disk drive including a base for a motor according to an embodiment of the present invention;

FIG. 2 is an exploded bottom perspective view schematically showing an arrangement relationship between the base for a motor and a substrate according to the embodiment of the present invention;

FIG. 3 is a bottom perspective view schematically showing a coupled relationship between the base for a motor and the substrate according to the embodiment of the present invention;

FIG. 4 is a schematic side cross-sectional view when viewed in a direction A of FIG. 3;

FIGS. 5A and 5B are cross-sectional views schematically showing a method of manufacturing a male rail and a state after the male rail is manufactured according to an embodiment of the present invention;

FIGS. 6A and 6B are cross-sectional views schematically showing a method of manufacturing a male rail and a state after the male rail is manufactured according to another embodiment of the present invention;

FIGS. 7A and 7B are cross-sectional views schematically showing a method of manufacturing the male rail and a state after the male rail is manufactured according to another embodiment of the present invention;

FIGS. 8A and 8B are cross-sectional views schematically showing a method of manufacturing the male rail and a state after the male rail is manufactured according to another embodiment of the present invention; and

FIGS. 9A through 9C are reference views showing a coupling process between the base for a motor and the substrate according to the embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

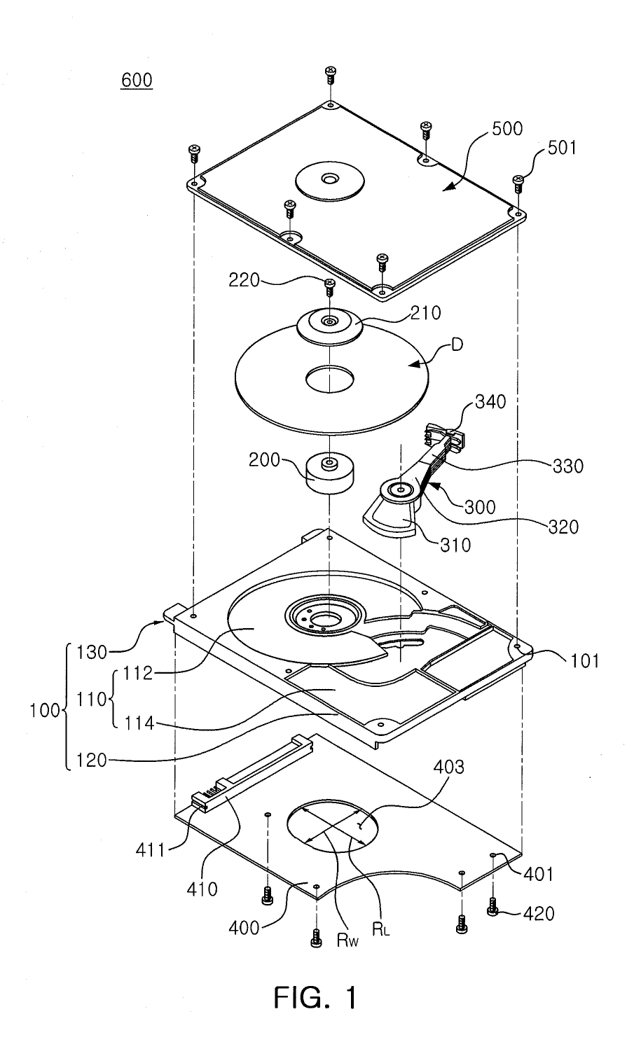

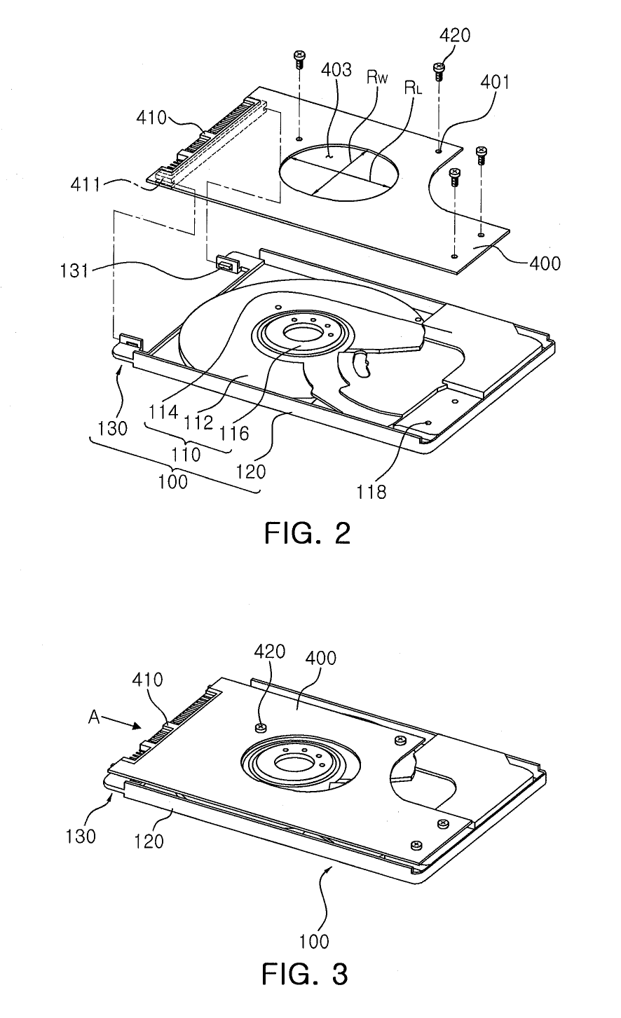

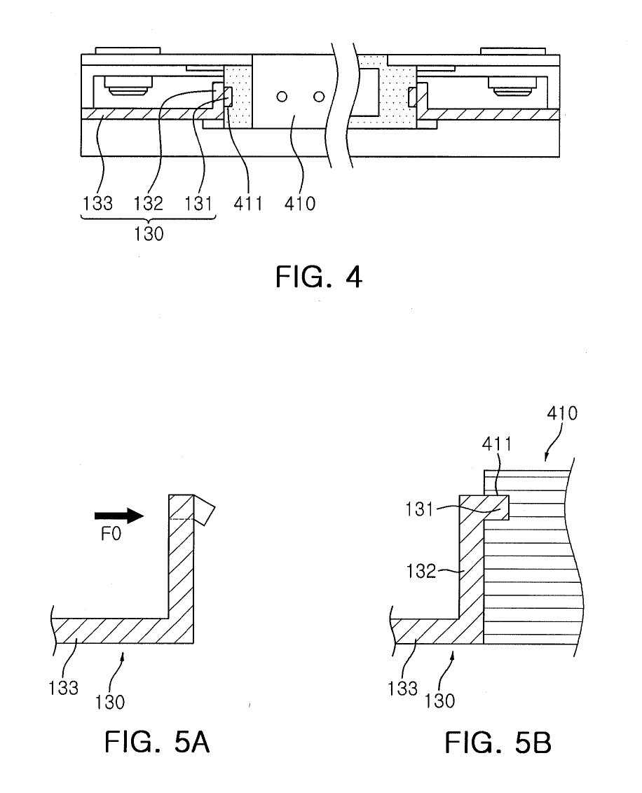

FIG. 1 is an exploded perspective view schematically showing a hard disk drive including a base for a motor according to an embodiment of the present invention. FIG. 2 is an exploded bottom perspective view schematically showing an arrangement relationship between the base for a motor and a substrate according to the embodiment of the present invention. FIG. 3 is a bottom perspective view schematically showing a coupled relationship between the base for a motor and the substrate according to the embodiment of the present invention. FIG. 4 is a schematic side cross-sectional view when viewed in a direction A of FIG. 3.

Referring to FIGS. 1 to 4, a hard disk drive 600 including a base 100 for a motor (hereinafter, referred to as a base) according to an embodiment of the present invention may include a spindle motor 200 and a head driver 300 for moving a magnetic head.

Terms with respect to directions will be first defined. An upward or downward axial direction refers to a direction from an upper surface of the base 100 toward a cover 500 or a direction opposite thereto, and an outer or inner radial direction refers to a direction from an outer wall part 120 of the base 100 toward the center of a disk D or a direction opposite thereto. In addition, a length direction may refer to a length direction of the hard disk drive and a width direction may refer to a width direction of the hard disk drive.

The base 100 may be a housing forming an exterior appearance together with the cover 500 in the hard disk drive 600 according to the embodiment of the present invention, and include a base body 110, the outer wall part 120, and a fixing part 130.

Here, the base 100 and the cover 500 may be coupled to each other by coupling a plurality of screws 501 to holes 101 formed in the base 100.

The base body 110 may have the disk D disposed thereon and the head driver 300 coupled thereto, and the disk D is coupled to the spindle motor 200 to be described below.

More specifically, the base body 110 may be partially protruded in the downward axial direction, wherein the partially protruded regions may be a disk receiving part 112 and a head seating part 114.

The disk receiving part 112 may generally have a circular shape so as to correspond to a shape of the disk, and the head seating part 114 is formed at the periphery of the disk receiving part 112 and is coupled to the head driver 300 capable of reproducing data stored on the disk D.

The outer wall part 120 may be formed at outer edges of the base body 110 to thereby define the outer surfaces of the base body 110 and be formed by bending edge portions of the base body 110.

Here, the base body 110 and the outer wall part 120 may be formed by a forging or pressing process and be manufactured by disposing a plate-shaped steel sheet, that is, a cold rolled steel sheet (SPCC, SPCE, or the like), a hot rolled steel sheet, a lightweight alloy steel sheet formed of a material such as stainless steel, boron or magnesium alloy, or the like, in a press mold and pressing the plate shaped steel at a predetermined pressure.

In other words, the shape of an internal space formed by a combination of upper and lower molds for pressing or forging corresponds to the shapes of the outer wall part 120 and the base body 110, such that the base 100 according to the embodiment of the present invention may be manufactured by a single process.

However, a basic shape of the base may be formed by a single pressing process, and then a final shape of the base 100 may be the formed by a bending process and an additional pressing process.

In this case, the outer wall part 120 may be formed by being bent at the outer edge portions of the base body 110 in the downward axial direction, or being bent therefrom in the upward axial direction and then bent in the downward axial direction.

The outer wall part 120 may be formed by the above-mentioned process, and the fixing part 130 for fixing a substrate 400 to which power is applied may be formed by performing an additional process.

Here, the fixing part 130 may support a connector part 410 mounted on the substrate 400. Thus, the fixing part 130 may be fitted in the connector part 410 in a simple sliding coupling manner without using a screw coupling at a portion at which the connector part 410 is coupled to the base body 110 due to a space limitation.

That is, the fixing part 130 may include a male rail 131 partially protruded in a length direction thereof and at least one side of the connector part 410 is provided with a female rail 411 partially depressed in a length direction thereof, such that the fixing part 130 may be fitted in the connector part 410 by the sliding coupling.

The male rail 131 may protruded from a flange part 133 of the fixing part 130 and coupled to the connector part 410.

Further, the male rail 131 may be protruded to the side of the connector part 410 from the flange part 133.

The detailed manufacturing method will be described below with reference to FIGS. 5 to 8.

Meanwhile, the base body 110 may include at least one female thread 118 so as to be screw coupled with the substrate 400 and the substrate 400 is provided with a screw coupling hole 401 at a position corresponding to the female thread 118 of the base body 110 so as to be additionally screw coupled with the base body 110.

The fixing part 130 may be coupled only to the connector part 410 mounted on an edge of the substrate 400. In order to firmly couple other portions of the substrate 400 to the base body 110, an additional screw coupling may be used.

Here, in order to slidably couple the substrate 400 to the base body 110, a seating hole 403 of the substrate 400 may be provided such that a diameter RL in a length direction of the substrate is larger than a diameter RW in the width direction. This considers a case in which each of the seating hole 403 and a rear protrusion part 116 has a rounded shape and the shapes of the seating hole and the rear protrusion part may be various.

The base 100 for a motor may be depressed such that the motor seating part is formed on one surface of the base body 110, whereby the rear protrusion part 116 partially protruded to the other surface of the base body 110 may be provided. The seating hole 403 may be provided such that the rear protrusion part 116 is fitted in the predetermined region of the substrate 400.

In this case, the seating hole 403 of the substrate 400 may have a larger diameter in the length direction than that of the rear protrusion part 116 in order that the rear protrusion part 116 is axially coupled to and fitted in the seating hole 403 of the substrate 400 and then, slidably coupled therewith in the length direction at a predetermined distance in a state in which the rear protrusion part 116 is fitted in the seating hole 403 of the substrate 400.

Therefore, the rear protrusion part 116 may serve as a stopper in the case in which the substrate is slidably coupled to the base body.

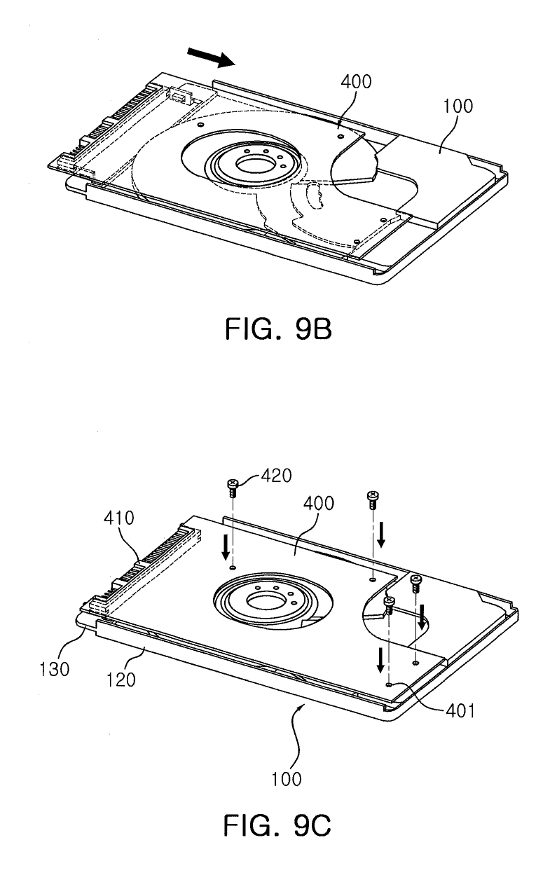

Hereinafter, referring to FIGS. 9A through C, a process of coupling the substrate to the base body will be described below.

The spindle motor 200, which is to rotate the disk D, is fixedly mounted to a central portion of the disk receiving part 112. The disk D may be coupled to the spindle motor 200 to thereby be rotated together with the spindle motor 200, and may have a writing surface to which data is written.

Here, a clamp 210 may be coupled to an upper end portion of the spindle motor 200 using a screw 220 in order to firmly fix the disk D to the spindle motor 200.

In addition, although FIG. 1 shows a configuration in which a single disk ID is mounted on the spindle motor 200, this configuration is only an example. That is, one or more disks D may be mounted on the spindle motor 200. In the case in which a plurality of disks D are mounted as described above, a ring-shaped spacer for maintaining an interval between the disks D may be disposed therebetween.

The head driver 300 is known as a head stack assembly (HAS) and may be a component having a magnetic head (not shown) mounted thereon and moving the magnetic head to a predetermined position to thereby write data to the disk D or read the data from the disk D.

The head driver 300 may include a voice coil motor (VCM) 310, a swing arm 320, and a suspension 330. The suspension 330 may be fixedly coupled to a front end portion of the swing arm 320.

In addition, the head driver 300 may be coupled to the base 100 so as to be rotatable around a pivot of the base 100. When the disk D rotates on the disk receiving part 112 of the base body 110 at a high speed, the magnetic head (not shown) serves to reproduce the data written on the writing surface of the disk D or write data to the writing surface of the disk D.

Here, the VCM 310, providing rotational driving force to the head driver 300, may include magnets disposed on upper and lower portions of a VCM coil of the head driver 300.

The VCM 310 may be controlled by a servo control system and rotate the head driver 300 around the pivot in a direction according to Fleming's left hand rule by an interaction between current input to the VCM coil and a magnetic field formed by the magnet.

Here, when an operation start command is input to the hard disk drive 600 according to the embodiment of the present invention, the disk D starts to rotate, and the VCM 310 rotates the swing arm 320 in a counterclockwise direction to thereby move the magnetic head (not shown) onto the writing surface of the disk D.

On the other hand, when an operation stop command is input to the hard disk drive 600 according to the embodiment of the present invention, the VCM 310 rotates the swing arm 320 in a clockwise direction to thereby allow the magnetic head (not shown) to move away from the disk D.

The magnetic head (not shown) deviating from the writing surface of the disk D is parked in a ramp 340 provided outside the disk D.

FIG. 5 is a cross-sectional view schematically showing a method for manufacturing a male rail and after the male rail is manufactured, according to the embodiment of the present invention.

Referring to FIG. 5, after the base body 110 and the flange part 133 are formed by a press or forging process and an additional machining process (a bending or press process), a protrusion part 132 of the fixing part 130 may axially extend from an end of the flange part 133.

Thereafter, the male rail 131 may be formed by bending an end portion of the protrusion part 132 in the inner radial direction through an exertion of force (F0).

The thickness of the male rail 131 may correspond to the thickness of the female rail 411 of the connector part 410 in which the male rail 131 is slidably fitted, but may also have a slight margin of error, as long as the male rail 131 may be fixed into the female rail 411.

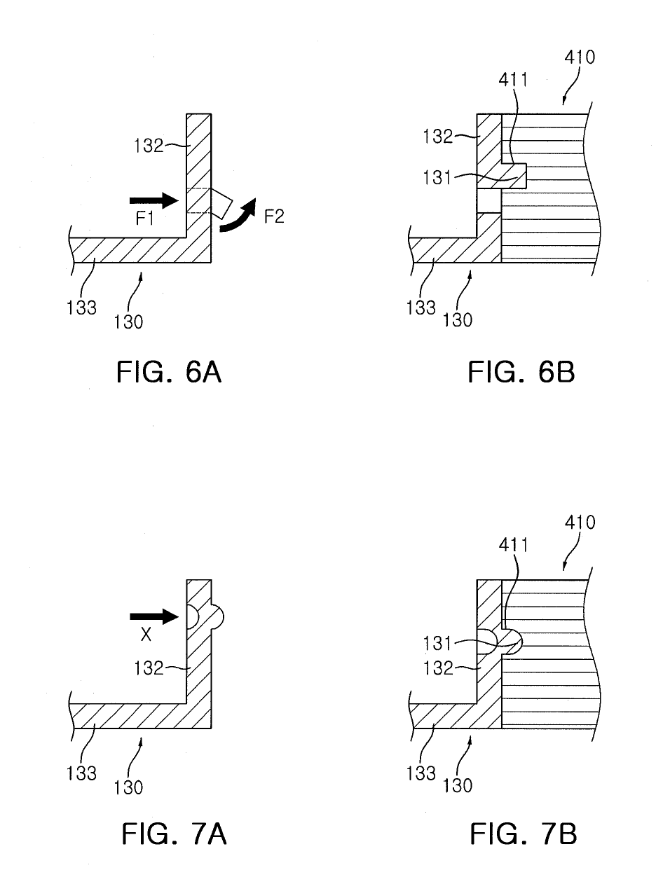

FIG. 6 is a cross-sectional view schematically showing a method for manufacturing a male rail and after the male rail is manufactured, according to another embodiment of the present invention.

Referring to FIG. 6, after the base body 110 and the flange part 133 are formed by a press or forging process and an additional machining process (a bending or press process), the protrusion part 132 of the fixing part 130 may axially extend from the end of the flange part 133.

The mail rail 131 may be formed by cutting a predetermined region of the protrusion part 132 by punching (F1), or the like, and then bending (F2) the cut region in the inner radial direction.

Here, the region cut in order to implement a shape of the male rail 131 may be sealed by a separate sealing member.

In addition, the thickness of the male rail 131 may correspond to the thickness of the female rail 411 of the connector part 410 in which the male rail 131 is slidably fitted, but may also have a slight margin of error, as long as the male rail 131 may be fixed into the female rail 411.

FIGS. 7A and 7B are cross-sectional views schematically showing a method of manufacturing the male rail and a state after the male rail is manufactured according to another embodiment of the present invention.

Referring to FIG. 7, after the base body 110 and the flange part 133 are formed by a press or forging process and an additional machining process (a bending or press process), the protrusion part 132 of the fixing part 130 may axially extend from the end of the flange part 133.

Here, the male rail 131 slidably fitted in the female rail 411 of the connector part 410 mounted on the substrate 400 may be formed by performing an embossing process on a predetermined region of the protrusion part 132.

That is, the male rail 131 may be formed to be protruded in the inner radial direction by pressing (X) a predetermined region of the protrusion part 132, in consideration of a depth of the female rail 411 or allowing for a slight margin of error, in the inner radial direction.

In other words, the male rail 131 may be formed by depressing one surface of the predetermined region of the protrusion part 132a such that the other surface thereof corresponding thereto may be protruded.

The male rail 131 protruded in the inner radial direction may have a cross-sectional shape close to a circular shape as shown in FIG. 7, but it is not limited thereto. That is, the male rail 131 may have any structure capable of being fitted in the female rail 411 of the connector part 410.

In addition, the thickness of the male rail 131 may correspond to the thickness of the female rail 411 of the connector part 410 in which the male rail 131 is slidably fitted, but may also have a slight margin of error, as long as the male rail 131 may be fixed into the female rail 411.

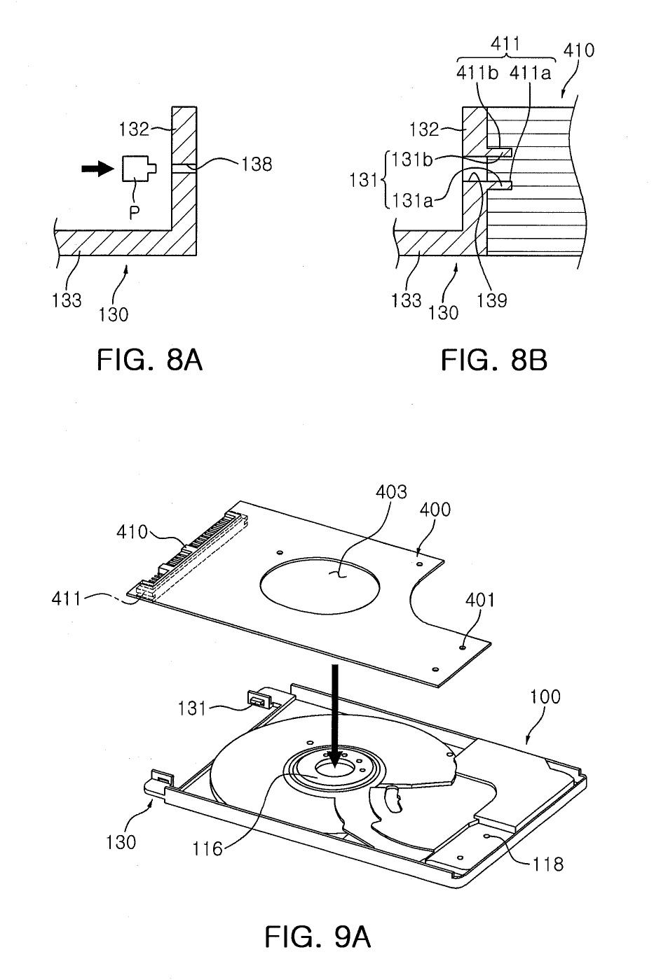

FIGS. 8A and 8B are cross-sectional views schematically showing a method of manufacturing the male rail and a state after the male rail is manufactured according to another embodiment of the present invention.

Referring to FIG. 8, after the base body 110 and the flange part 133 are formed by a press or forging process and an additional machining process (a bending or press process), the protrusion part 132 of the fixing part 130 may axially extend from the end of the flange part 133.

Here, the male rail 131 may be protruded by performing a burring process on a predetermined region of the protrusion part 132.

The male rail 131 may be protruded in the inner radial direction by punching a predetermined region of the protrusion part 132b to form a hole 138 and then pressing a punch P having a diameter slightly larger than that of the hole 138 toward the hole 138 in the inner radial direction. In this case, two male rails 131a and 131b may be vertically formed based on the hole 138.

The two male rails 131a and 131b formed by the above-mentioned burring process may be provided while having the hole 139 disposed therebetween and having a predetermined diameter, and correspondingly, the female rail 411 of the connector part 410 mounted on the substrate 400 may be provided as two female rails 411a and 411b vertically disposed.

Here, the hole 139 formed in order to implement a shape of the male rail 131 may be sealed by a separate sealing member.

In addition, the thickness of the male rail 131 may correspond to the thickness of the female rail 411 of the connector part 410 in which the male rail 131 is slidably fitted, but may also have a slight margin of error, as long as the male rail 131 may be fixed into the female rail 411.

FIGS. 9A through 9C are reference views showing a coupling process between the base for a motor and the substrate according to the embodiment of the present invention.

Referring to FIG. 9, the substrate 400 may be coupled to a bottom surface of the base body 110.

First, the substrate 400 may be coupled to the bottom surface of the base body 110 so as to be vertical thereto. In this case, the substrate 400 may be biased in an opposite direction of the sliding coupling by a predetermined distance in which the sliding coupling is performed, thereby being coupled to the base body 110 (FIG. 9A).

Next, the male rail 131 of the base body 110 may be fitted in the female rail 411 of the connector part 410 while the substrate 400 may slidably move by a predetermined distance in the length direction (FIG. 9B).

In this case, the seating hole 403 of the substrate 400 may have a larger diameter in the length direction than that of the rear protrusion part 116 so that the rear protrusion part 116 is axially fitted in the seating hole 403 of the substrate 400 and then, slidably coupled thereto in the length direction by a predetermined distance in a state in which the rear protrusion part 116 is fitted in the seating hole 403 of the substrate 400.

Thereby, when the substrate 400 is slidably coupled to the base body, the rear protrusion part 116 may serve as a stopper of the seating hole 403 provided in the substrate 400.

Finally, the female thread 118 mounted on a predetermined region of the bottom surface of the base body 110 and a screw coupling hole 401 provided in the substrate 400 to correspond to the female thread 118 may be coupled to each other by a male screw, such that the substrate 400 may be firmly coupled to the base body 100 in a screw coupling manner.

The fixing part 130 may be coupled only to the connector part 410 mounted on an edge of the substrate 400. In order to firmly couple other portions of the substrate 400 to the base body 110, an additional screw coupling may be used.

According to the above-mentioned embodiments, productivity can be improved and production costs can be minimized, by increasing space utilization in the coupling of the base manufactured by the press or forging process and the substrate for applying power.

In addition, the fixing part 130 including the flange part 133, the protrusion part 132, and the male rail 131 may be manufactured by performing a bending, curving, or embossing process on a plate-shaped steel sheet, a mother body of the base 100, whereby the fixing part 130 may be realized during the production process of the base 100.

As set forth above, the base for a motor and the hard disk drive including the same according to the embodiments of the present invention can simplify the coupling structure between the base and the substrate even in the case of using the press or forging process.

In addition, the embodiments of the present invention can minimize the processing time and the energy consumption by manufacturing the base for a motor by the forging or press process, thereby improving production capability.

While the present invention has been shown and described in connection with the exemplary embodiments, it will be apparent to those skilled in the art that modifications and variations can be made without departing from the spirit and scope of the invention as defined by the appended claims.

What is claimed is:

1. A base for a motor, comprising:
a base body having a disk disposed thereon; and
a fixing part formed on the base body and slidably fitted in a female rail mounted on at least one side of a connector part mounted on a substrate to fix the base body to the substrate to which power is applied.

2. The base for a motor of claim 1, wherein the fixing part is a male rail protruded in a lateral direction of the connector part so as to be slidably fitted in the female rail.

3. The base for a motor of claim 2, wherein the male rail is formed by depressing a surface of a predetermined region of the base body to protrude the other surface thereof.

4. The base for a motor of claim 2, wherein the male rail is formed by bending a predetermined region of the base body.

5. The base for a motor of claim 2, wherein the male rail is protruded by performing a burring process on the predetermined region of the base body.

6. The base for a motor of claim 1, wherein the base body includes at least one female thread so as to be additionally screw coupled with the substrate.

7. The base for a motor of claim 1, wherein the base body is formed by a press process.

8. A hard disk drive, comprising:
the base for a motor of claim 1;
a spindle motor coupled to the base for a motor and rotating the disk by the power applied through the substrate;
a magnetic head writing data to the disk and reproducing the data stored on the disk; and
a head driver moving the magnetic head to a predetermined position with regard to the disk.

9. The hard disk drive of claim 8, wherein the substrate has a connector part mounted to be protruded from one surface thereof.

10. The hard disk drive of claim 8, wherein the base for a motor is depressed such that a motor seating part is formed on one surface of the base body and includes a rear protrusion part partially protruded to the other surface thereof and,
a predetermined region of the substrate includes a seating hole to allow the rear protrusion part to be fitted therein.

11. The hard disk drive of claim 10, wherein the seating hole of the substrate has a larger diameter in a length direction than that of the rear protrusion part so that the rear protrusion part is axially fitted in the seating hole of the substrate and then, slidably coupled thereto in the length direction by a predetermined distance in a state in which the rear protrusion part is fitted in the seating hole of the substrate.

12. The hard disk drive of claim 11, wherein the rear protrusion part serves as a stopper at a time of sliding coupling of the substrate.

13. The hard disk drive of claim 8, wherein the substrate includes a screw coupling hole at a position corresponding to a female thread mounted on the base body of the base for a motor, thereby being additionally screw coupled with the base body.

14. The hard disk drive of claim 11, wherein the substrate is additionally screw coupled with the base body after sliding coupling of the substrate.
